(19) United States
(12) Patent Application Publication
(10) Pub. No.: US 2013/0150998 A1
(43) Pub. Date: Jun. 13, 2013

(54) MANAGING APPARATUS OF SEMICONDUCTOR MANUFACTURING APPARATUS AND COMPUTER PROGRAM

(71) Applicants: Ryoichi Matsuoka, Yotsukaido (JP); Norio Hasegawa, Hinode (JP); Hiroaki Mito, Hitachinaka (JP)

(72) Inventors: Ryoichi Matsuoka, Yotsukaido (JP); Norio Hasegawa, Hinode (JP); Hiroaki Mito, Hitachinaka (JP)

(73) Assignee: HITACHI HIGH-TECHNOLOGIES CORPORATION, Tokyo (JP)

(21) Appl. No.: 13/818,643

(22) PCT Filed: Jun. 15, 2011
(86) PCT No.: PCT/JP2011/003393

§ 371 Date: Feb. 22, 2013

(30) Foreign Application Priority Data
Aug. 30, 2010 (JP) 2010-191648

(51) Int. Cl. G05B 19/418

(52) U.S. Cl. CPC G05B 19/4183
USPC 700/121

(57) ABSTRACT

An object of the present invention is to provide a managing apparatus of a semiconductor manufacturing apparatus and a computer program capable of performing an accurate process monitoring based on the obtained pattern image and the like. To accomplish the above object, according to one aspect of the present invention, there are proposed a managing apparatus of a semiconductor manufacturing apparatus including a library which stores an association between shape information of a pattern of a plurality of positions and an exposure condition of an exposing device and a calculation device which compares the shape information of the plurality of positions extracted from image information with the shape information stored in the library, and extracts the exposure condition based on a logical product of a range of a plurality of exposure conditions corresponding to the shape information of the plurality of patterns extracted from the image information, and a computer program which executes the above processes.

### TECHNICAL FIELD

The present invention relates to a managing apparatus of a semiconductor manufacturing apparatus and a computer program to execute the management in a computer, and in particular, relates to a managing apparatus of a semiconductor manufacturing apparatus and a computer program which enable a process monitoring of an exposing device for exposing a semiconductor pattern.

### BACKGROUND ART

Recently, according to progress of miniaturization technology in a manufacture of a semiconductor device, a pattern to be formed on a semiconductor wafer is miniaturized, so that an exposing device used for forming a pattern like this is requested to have a high NA (lens numerical aperture). Accordingly, variation factors of the pattern to be formed tend to be complicated and enlarged.

Accordingly, it is necessary to always manage the state of the exposing device in the manufacturing process of the semiconductor. Whenever the exposing device has a failure, it is necessary to stop the operation of the exposing device and adjust the state of the exposing device. There are many variation factors in the exposing device, and according to these variation factors, Focus (focusing state) or Dose (the state of an exposure amount) of the exposing device changes, so that the shape of a pattern to be formed changes. If the desired pattern shape is not able to be transferred, the yield of the semiconductor device is lowered, therefore the management of the exposing device needs to be accurately performed.

The PTL 1 has proposed a method in which in a process monitoring of an exposing device, a highly isolative pattern, of which a cross-sectional shape is greatly changed by fluctuations in an exposure amount and a focal position, is an observation target, and which estimates the variation in the exposure amount and the focal position by comparing image information obtained by an electron microscope or the like with model data which is formed by changing an exposure condition of the exposing device. In addition, PTL 2 discloses a method of performing a process monitoring based on the cross sectional shape of a pattern. Furthermore, PTL 3 discloses a method which monitors a process by comparing a characteristic amount of a stereoscopic shape pattern image obtained based on a SEM image with an estimated model and correctly specifying the cross sectional shape. Furthermore, PTL 4 proposes a process monitoring which regards parts, in which a shape of a pattern is greatly changed, as an evaluation object. Further, PTL 5 proposes an apparatus of evaluating a pattern shape in which roundness and the like of a corner portion of a pattern is an evaluation object.

### CITATION LIST

### Patent Literature

[PTL 1] JP-A-2005-064023 (corresponding U.S. Pat. No. 6,929,892)
[PTL 2] JP-A-2007-227618 (corresponding US Patent Publication No. 2007/0198955)
[PTL 3] JP-A-2007-129059 (corresponding US Patent Publication No. 2007/0105243)
[PTL 4] JP-A-2009-206453 (corresponding US Patent Publication No. 2009/0231424)
[PTL 5] JP-A-2006-126532 (corresponding U.S. Pat. No. 7,449,689)

### SUMMARY OF INVENTION

### Technical Problem

Although PTLs 2 and 4 describe that a process evaluation is performed based on an evaluation of apart in which a change in a pattern shape is large or the cross sectional shape and PTLs 1 and 3 describe that a process evaluation is performed by comparing the cross sectional shape of a pattern with a model, a possibility that a focus value or an exposure amount which is specified by the pattern evaluation may have an extensity that is not described. In addition, PTL 5 does not disclose that the shape evaluation is applied to a process monitoring. Since there is a possibility that a focus value or an exposure amount with respect to one model data may broadly reach, a correct focus value or a correct exposure amount may not be specified only by a simple comparison of the obtained shape data and model data.

Further, in a method for specifying a model using one-dimensional pattern information (dimension value) or three-dimensional pattern shape (cross sectional shape), an estimated focus value or an estimated exposure amount also has a width, therefore a correct focus value or a correct exposure amount may not be specified.

Hereinafter, a managing apparatus of a semiconductor manufacturing apparatus and a computer program are proposed, of which the object is to perform an accurate process monitoring based on an obtained pattern image and the like.

### Solution to Problem

As an aspect to accomplish the above object, there is proposed a managing apparatus of a semiconductor manufacturing apparatus including a library which stores an association between curvature information of a curved portion of a pattern and an exposure condition of an exposing device or a flag provided to specify the exposure condition; and, a calculation device which compares curvature information of a pattern extracted from image information with the curvature information stored in the library and extracts an exposure condition or a flag corresponding to the curvature information of the pattern extracted from the image information, and a computer program which executes the above processes.

In addition, as another aspect to accomplish the above object, there is proposed a managing apparatus of a semiconductor manufacturing apparatus including a library which stores an association between shape information of patterns of a plurality of positions and an exposure condition of an exposing device or a flag provided to specify an exposure condition, and a calculation device which compares the shape information of the plurality of positions extracted from image information with the shape information stored in the library, and extracts the exposure condition based on a logical product of a range of a plurality of exposure conditions corresponding to the shape information of the plurality of patterns extracted from the image information and a range of a plurality of exposure conditions obtained based on a plurality of a flags provided to specify a range of the exposure condition, and a computer program which executes the above processes.

### Advantageous Effects of Invention

According to the above configuration, it is possible to perform an accurate specification of an exposure condition of an exposing device.

### BRIEF DESCRIPTION OF DRAWINGS

FIG. 1 is a diagram illustrating a variation in focus of an exposing device in a manufacturing process of a semiconductor.

FIG. 2 is a diagram illustrating an example of a shape of a pattern for monitoring an exposure condition.

FIG. 3 is a diagram illustrating an outline of a preparation process of a monitor pattern library.

FIG. 4 illustrates an outline of a process for estimating an exposure amount and a focus amount using a prepared library.

FIG. 5 is a diagram illustrating an example of a graph showing a relationship between the curvatures formed based on information stored in the DF estimation library and the focus amount of the exposing device.

FIG. 6 is a diagram illustrating an example in which the libraries of two patterns are compared with the curvature data and a focus width of each of the patterns is calculated.

FIG. 7 is a diagram illustrating a process for obtaining superimposed regions (AB_DWR, AB_DWL) of focus widths of two patterns.

FIG. 8 is a diagram illustrating an example in which refinement of the exposure condition is performed using information relating to a white band.

FIG. 9 is a diagram illustrating other pattern information for performing refinement of the exposure condition.

FIG. 10 is a diagram illustrating relationships between characteristic amounts of the pattern and exposure conditions.

FIG. 11 is a diagram illustrating relationships between characteristic amounts of the pattern and exposure conditions.

FIG. 12 is a diagram illustrating an example for estimating a dose amount of the exposing device based on the characteristic amounts of a pattern.

FIG. 13 is a diagram illustrating an outline of a FD monitor pattern.

FIG. 14 is a diagram illustrating an example for obtaining the curvature of the pattern.

FIG. 15 is a diagram illustrating an example for obtaining the curvature of the pattern.

FIG. 16 is a diagram illustrating an example of the monitor pattern.

FIG. 17 is a diagram illustrating an example of the monitor pattern.

FIG. 18 is a diagram illustrating an example in which an interval between holes changes according to a change in the focus condition of the exposing device.

FIG. 19 is a diagram illustrating an example in which side wall information of the pattern is extracted.

FIG. 20 is a diagram for illustrating an example in which a pattern that is not present in product design data is installed as a monitor pattern on a wafer.

FIG. 21 is a flowchart showing an exposure condition estimation process using the DF estimation library.

FIG. 22 is a diagram illustrating an outline of a calculation apparatus, which estimates the exposure condition.

FIG. 23 is a diagram illustrating an example of the library, which is stored in a library storing unit.

FIG. 24 is a schematic explanatory diagram of the measurement or monitoring system in which a plurality of measuring or monitoring apparatuses are connected to a network.

FIG. 25 is a schematic configuration diagram of a scanning electron microscope.

FIG. 26 is a diagram illustrating a process for extracting a profile line from a pattern edge.

FIG. 27 is a flow chart for showing a profile line extraction process.

### DESCRIPTION OF EMBODIMENTS

Inventors have newly discovered a phenomenon where due to an influence based on the variation in a focus value or an exposure amount, a big change occurs in shapes in corners of patterns (a connecting portion between two patterns having longitudinal directions in different directions, or the like) or a corner portion of a pattern (an apex angle portion). Therefore, in the present embodiment, a new managing apparatus of a semiconductor manufacturing apparatus and a computer program are proposed, in which the above portions are set as objects of shape evaluation, and a library which stores the association between the above portions and an exposure condition of an exposing device is prepared, thereby realizing a correct exposure condition by referring to the library.

Further, the inventors have newly discovered that, on design data, a plurality of parts having different angles, parts having the same angle but being present in different positions, and the like show a different shape change in response to the change in the exposure condition. For example, on design data, in a L-shaped pattern, if the inner portion (the inner corner) of the curved portion of the pattern is formed with 270 degree, the outer portion (the outer corner) of the curved portion of the pattern is formed with 90 degree (the angle of the side in which the pattern exists). As the above, the parts formed with different angles show different patterns shapes in response to the change in the exposure condition. Thus, in the present embodiment, based on the new knowledge, a managing apparatus of a semiconductor manufacturing apparatus and a computer program are proposed in which a plurality of pattern parts are set as objects for shape evaluation and a logical product of the exposure conditions obtained based on the corresponding evaluation results, and thus refinement of the exposure condition is performed. On the other hand, by employing a plurality of patterns of the same shape, the reproducibility using an average is increased.

Further, in the present embodiment, a method is described, which evaluates an exposure status using a dedicated monitor pattern for detecting the exposure status, however, if a pattern corresponding to the monitor pattern exists in a pattern constituting a semiconductor device circuit, the exposure condition may be evaluated using the pattern.

In addition, the library is prepared by performing an exposure with respect to a pattern for library preparation for each combination of different focus conditions and exposure amount conditions, and an image acquisition with respect to the pattern formed by the exposure using a Scanning Electron Microscope (SEM). More specifically, the library is prepared through the library preparation process in which, based on the different focus conditions and different exposure amount conditions, a focus dose matrix (also referred to as Focus Exposure Matrix (FEM)) wafer is prepared, and information necessary for library preparation is extracted from the SEM image of the same parts in the pattern formed under the different exposure conditions.

Using the prepared library, various information is received from the pattern to be measured which is actually desired to be monitored, and the library information and the pattern information to be measured are contrasted, and thus a focus in which the library information and the pattern information are closest with each other, a focus in which an exposure amount condition is drawn, and the exposure amount condition are monitored. Based on the monitor, it becomes possible to catch variations in an exposing device (a scanner or a stepper) in in-line process (mass production process).

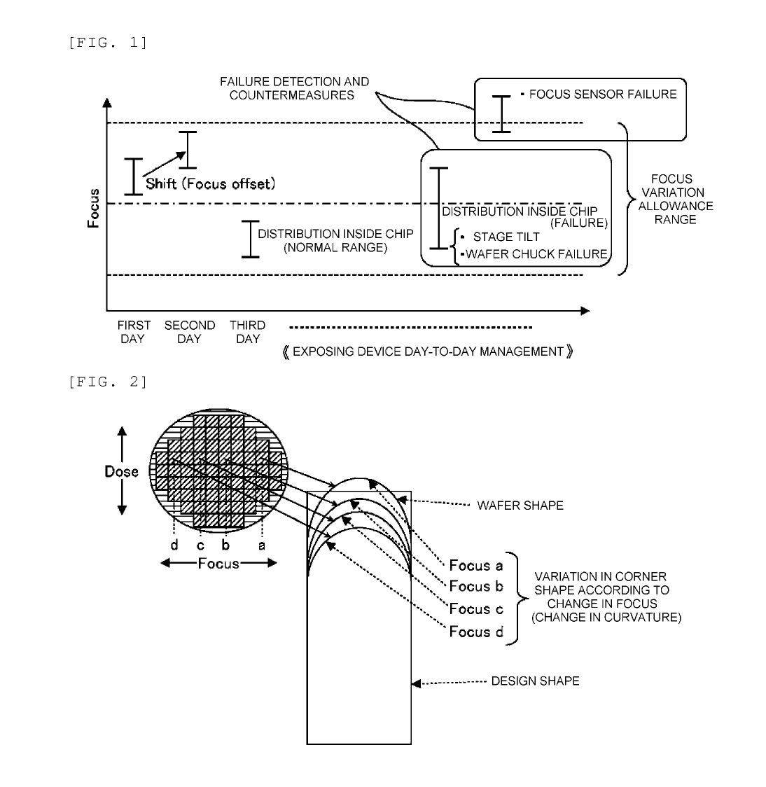

As shown in FIG. 1, in the manufacturing process of the semiconductor, the pattern shape to be exposed may change over time due to a stage tilt of the exposing device or a wafer chuck failure, a focus sensor failure and the like. Due to the causes of variation, variation such as a small deviation in focus (focus offset) or a small unevenness of the shape in a chip and the like always occurs (focus variation allowance range).

However, even within the allowance range, if a variation in the shape in the chip becomes large, from a viewpoint of a uniformity of the pattern finish, adjustment becomes necessary. In addition, due to the focus sensor failure and the like, patterns that exceed the allowance range may be transferred. Accordingly, it is extremely important to always monitor the status of the variation for the stable manufacturing of the semiconductor. A method for managing the exposing device, which performs the exposure using the dedicated wafer and measures the dimension of the exposed transfer pattern in a one-dimensional manner using a CD-SEM (Critical Dimension—SEM), thereby monitoring variations in the exposing device has been known. Further, it is possible to manage the exposing device using an OCD (an optical CD measurement method), but since the OCD performs an average measurement, it needs to form one-dimensional patterns of the same shape in large amounts in a comparably broad area, and a dedicated wafer is also needed. In addition, in the measurement using the OCD, since only one-dimensional line patterns may be dealt with, the sensitivity is not known to be sufficient with respect to the variations in the focus or the dose. Further, it becomes unsuitable for an accurate management of the focus and the dose when considering a two-dimensional shape.

Further, if considered from the viewpoint of production efficiency, it is extremely necessary to prevent the exposing device from stopping for the various managements issues above in the mass production process from the viewpoint of productivity. In addition, it is necessary to prevent the dedicated wafer from being used for this.

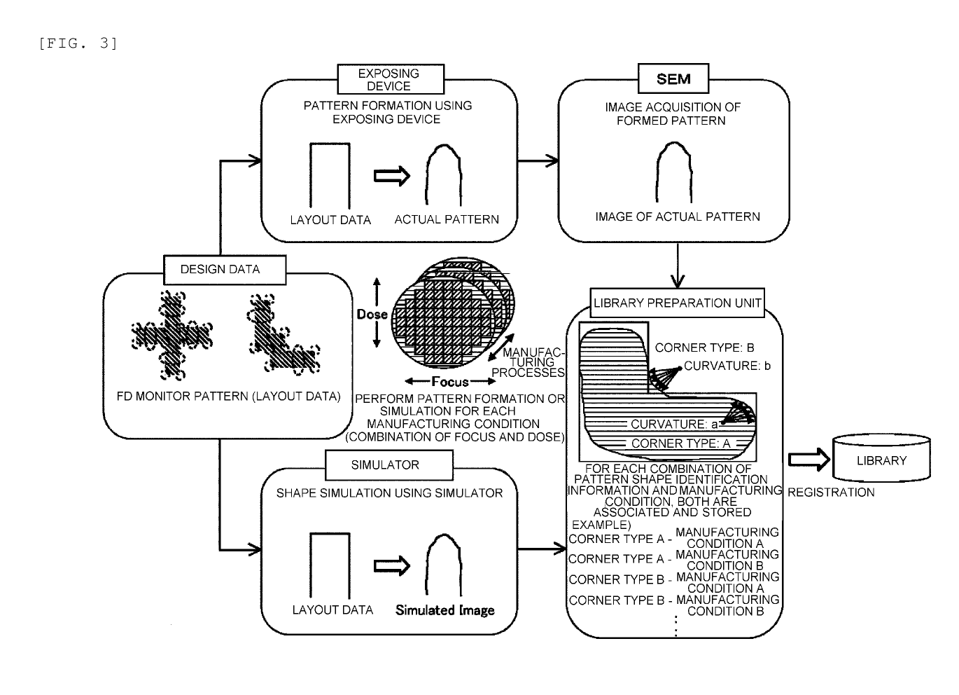

In the present embodiment, as shown in FIG. 2, not the one-dimensional information or three-dimensional information of the pattern, but mainly the shape (that is, two-dimensional shape) of the part including the corner of the pattern is set as an object of the monitor. Since the corner portion sensibly reacts to the variations in the focus condition of the exposing device, the corner portion is monitored; high accurate exposure condition estimation becomes possible.

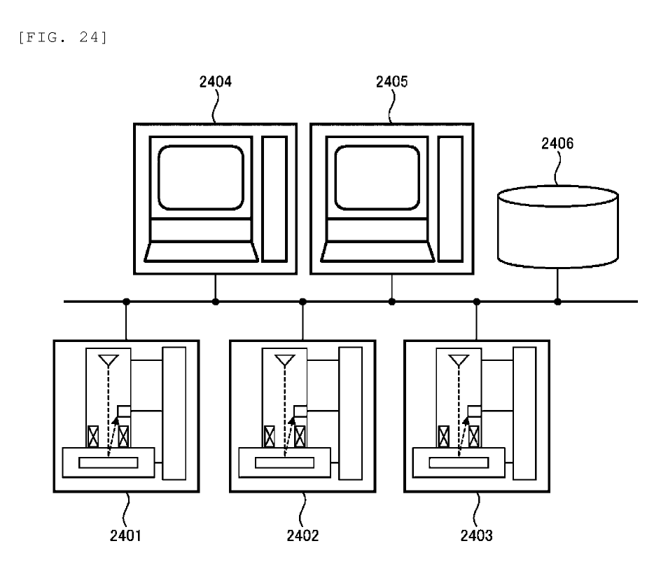

FIG. 24 is a schematic explanatory diagram of the measurement or monitoring system in which a plurality of measuring or monitoring apparatuses are connected to a network. The system mainly includes a CD-SEM 2401 which measures a pattern dimension of a semiconductor wafer, a CD-SEM 2402 which measures a pattern dimension of a photo mask, and a defect review SEM (DR-SEM 2403) which monitors defection based on position information of the defect. In addition, a managing apparatus 2404 in which a control unit for managing an exposing device described later is embedded, a simulator 2405 which simulates a pattern finish based on design data of a semiconductor device and a manufacturing condition of a semiconductor manufacturing apparatus and the like, and a storing medium 2406, which stores layout data of a semiconductor device or design data in which a manufacturing condition is registered, are connected to the network.

Design data is expressed, for example, in a GDS format or an OASIS format and the like, and is stored in a predetermined type. Further, if software for design data may express the design data in that format type and may deal the design data as graphic data, the kind of the design data does not matter. In addition, the storing medium 2406 may be embedded in a measurement apparatus, a control apparatus of a monitoring apparatus, the managing apparatus 2404 or the simulator 2405.

Further, the CD-SEMs 2401 and 2402 and the DR-SEM 2403 include respective control apparatuses which perform control necessary for each apparatus. However, the control apparatuses may have the function of the simulator or a function of setting a measurement condition.

In the SEM, an electron beam emitted from an electron source is focused on lenses of a plurality of stages and the focused electron beam is scanned in a one-dimensional or two-dimensional manner on a sample by a scanning deflector.

A Secondary Electron (SE) emitted from the sample by scanning of the electron beam or a Backscattered Electron (BSE) is detected by a detector, synchronized with a scan by the scanning deflector, and stored in the storing medium such as a frame memory. An image signal stored in the frame memory is calculated by a calculation device mounted in the control apparatus. Further, the scanning by the scanning deflector is possible in any dimension, position and direction.

The controls described above are performed in a control apparatus of each SEM. As a result of the scanning of the electron beam, the obtained image or signal is transmitted to the managing apparatus 2404 through a communication circuit network. Although it is described that the control apparatus which controls the SEM and the managing apparatus 2404 are configured by a separate apparatus in the present embodiment, without being limited thereto, the managing apparatus 2404 may be configured to collectively perform the control of the apparatus and the measurement process, or each control apparatus may be configured to perform both the control of the SEM and the measurement process.

In addition, a program for performing the measurement process is stored in the managing apparatus 2404 or the control apparatus, and the measurement or the calculation is performed according to the program.

In addition, the managing apparatus 2404 has a function to prepare a program (a recipe), which controls the operation of the SEM, based on the design data of the semiconductor, and the managing apparatus 2404 functions as a recipe setting unit. Specifically, positions such as the desired measurement points on the design data, profile line data of a pattern, or the design data to which a simulation is performed, an auto focus point, an auto stigma point and an addressing point in which necessary processes are performed by the SEM are set, and based on the setting, the program for automatically controlling a sample stage of the SEM or the deflector is prepared.

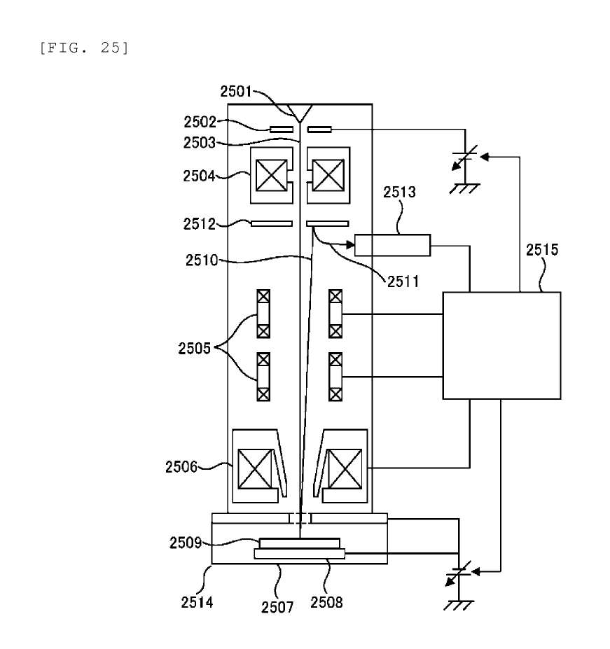

FIG. 25 is a schematic configuration diagram of a scanning electron microscope. Electron beam 2503, which is drawn from an electron source 2501 by a drawer electrode 2502 and is accelerated by an accelerating electrode which is not shown, is narrowed down by a condenser lens 2504 that is a form of a focusing lens, and then is scanned in one-dimensional or two-dimensional manner on a sample 2509 by a scanning deflector 2505. The electron beam 2503 is decelerated by a negative voltage that is applied to the electrode embedded in a sample board 2508 and focused by a lens action of an object lens 2506 to be irradiated on the sample 2509.

If the sample 2509 is irradiated with the electron beam 2503, electrons 2510 such as the secondary electron and the backscattered electron are emitted from the irradiated parts. The emitted electron 2510 is accelerated in the direction of an electron source by an accelerating action based on the negative voltage applied to the sample, and collided with a conversion electrode 2512, therefore a secondary electron 2511 is generated. The secondary electron 2511 emitted from the conversion electrode 2512 is captured by a detector 2513, and the output of the detector 2513 is changed due to the captured secondary electron amount. According to the output, the brightness of the display which is not shown is changed. For example, in a case of forming a two-dimensional image, a deflection signal toward the scanning deflector 2505 and the output of the detector 2513 are synchronized with each other, so that the image of the scanning region is formed. Although in the example of FIG. 25, the example is described in which the electron emitted from the sample is converted once in the conversion electrode and detected, of course, without being limited to the configuration, for example, a configuration to dispose the detected surface of an electron multiplier tube or the detector is provided on the orbit of the accelerated electron is possible.

A controller 2515 controls each configuration of the scanning electron microscope, and has a function to form an image based on the detected electron and a function to measure a pattern width of the pattern formed on the sample based on the strength distribution of the detected electron which is referred to as a line profile.

In the managing apparatus 2404 shown in FIG. 24, three jobs are mainly performed. First, a library is prepared which stores the association between the exposure conditions and the shape information of the pattern obtained for each of the different exposure conditions. Second, the shape information of the pattern is obtained based on images obtained by the SEM and the like. Third, the exposure condition (referred to as an exposure amount (Dose) or an Exposure) and a focal position (referred to as a focus amount) of the exposing device are estimated by contrasting the obtained shape information with the library stored in advance.

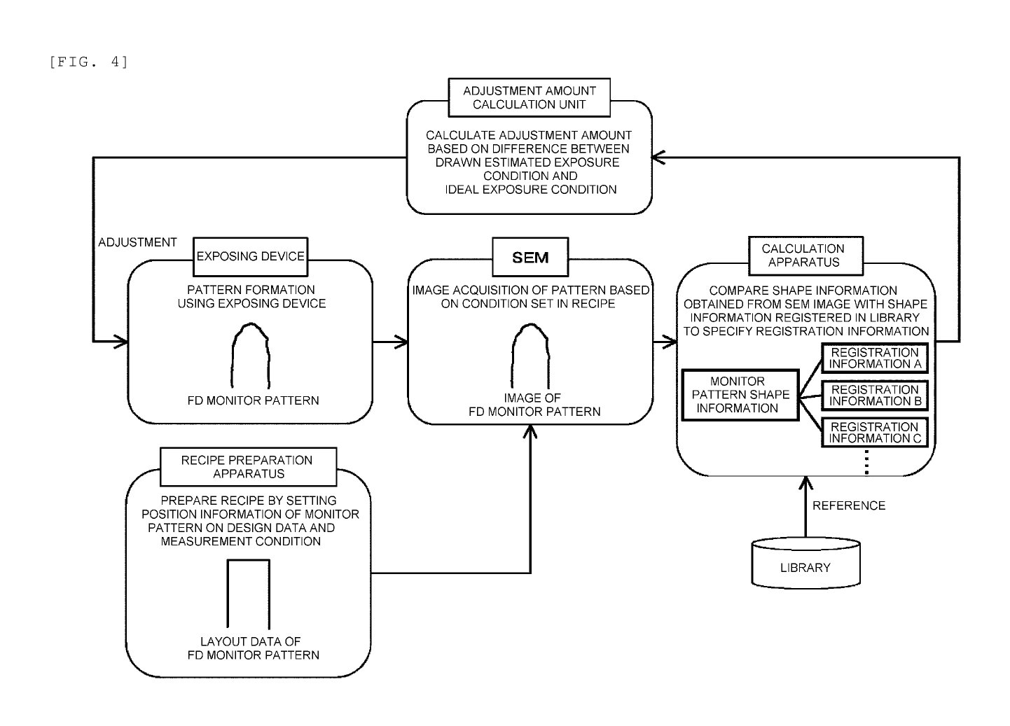

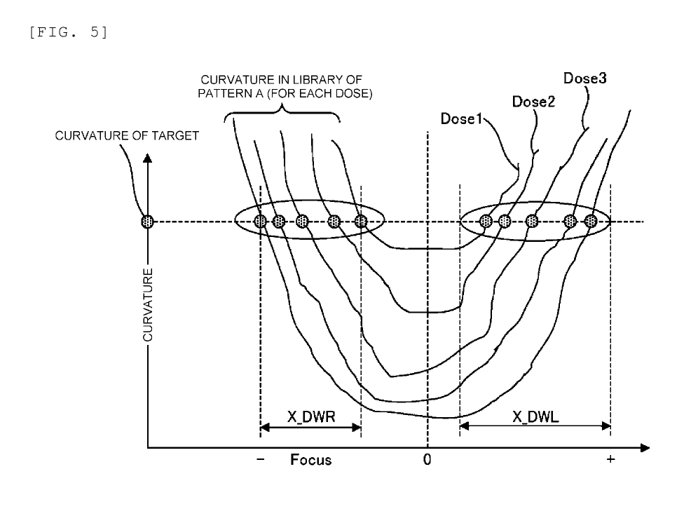

FIG. 3 and FIG. 4 explain the outline of the process for preparing a monitor pattern library and the outline of the process for estimating an exposure amount and a focus amount using the prepared library. First, a pattern (FD monitor (Focus Dose monitor) pattern) to be used for estimating the exposure amount and the focus amount is prepared in advance. On the layout data, even the data has the same shape, since the pattern shape is also changed when the exposure condition is changed, the exposure condition of the exposing device is changed and the pattern is prepared for each different exposure condition. As an example, a pattern of a different exposure condition is formed by preparing a FEM wafer. With regard to the pattern for each exposure condition formed in this manner, a SEM image is acquired, and the exposure condition is associated with the shape information to be stored in the library. In the example of FIG. 3, associations between parts having different patterns (corner type A, corner type B) and different exposure conditions (manufacturing conditions) are stored in the library.

In the step of preparing the library, the monitor pattern, with which estimation (DF estimation) of a dose and a focus is performed, is exposed and the various characteristic amounts of the pattern is registered in the DF estimation library. In the present embodiment, a monitor pattern having an angular corner pattern such as a cross-shaped pattern having a high sensitivity with respect to the focus change or a pattern having a plurality of corner portions, is transferred on to the wafer, and the library is prepared based on the SEM image acquisition of the each pattern.

In the present embodiment, the above wafer is a wafer which is dedicated for preparation of the library and prepared to have a desired optical condition (NA and the like) for each layer (each layer constituting a semiconductor, which is referred to as a diffusion process, a poly silicon process and a first metal) of a product device.

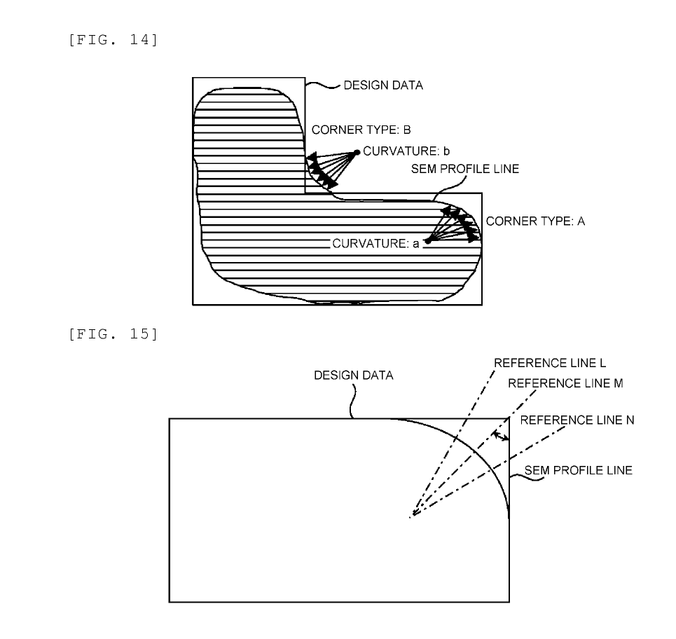

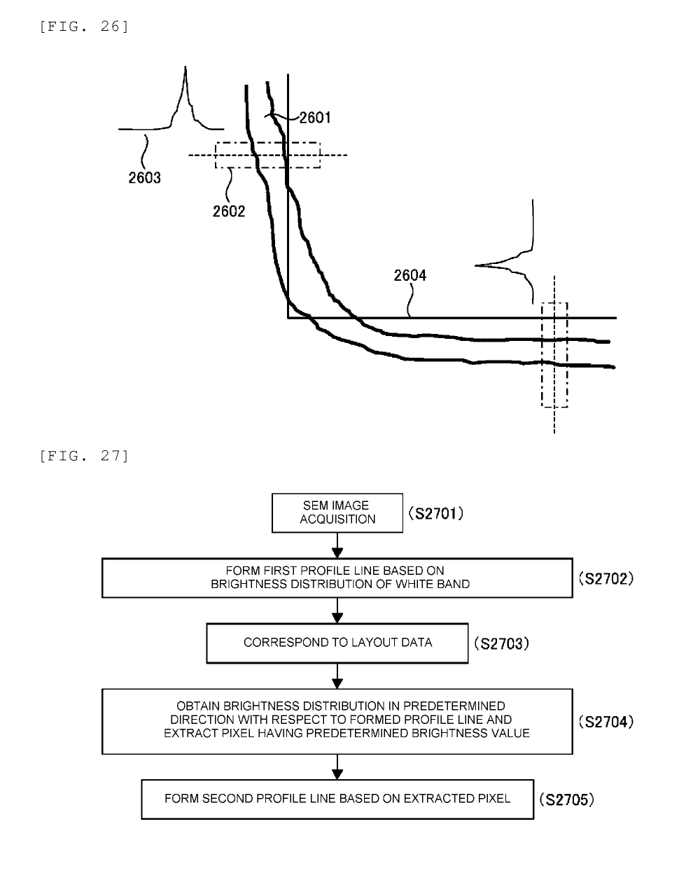

The information for each part of the monitor pattern formed as above is extracted as information to be registered in the library. Specifically, a curvature of a pattern constituting a corner portion or a line width of the pattern is calculated, and information such as the curvature and the line width is associated with the exposure condition to be registered in the library. As shown in FIG. 14, the curvature is calculated based on the profile line extracted from the SEM image. Specifically, as shown in FIG. 26, based on brightness distribution information 2603 of a white band 2601 of the pattern on the SEM image, the profile line is extracted. The brightness distribution information 2603 is prepared based on the extraction of the brightness change in a brightness distribution extraction region 2602. FIG. 27 is a flow chart illustrating an extraction process of the profile line.

The profile line extraction may be performed in the calculation apparatus mounted in the managing apparatus 2404 or in the control apparatus connected to the SEM. In the profile line extraction, as shown in the flow chart of FIG. 27, first, a SEM image is formed using a scanning electron microscope (step 2701). Next, a first profile line is extracted based on the brightness information distribution information from the white band 2601 on the SEM image (step 2702). In addition, as an extraction method of the first profile line, a method is considered, in which a pattern image configured by bit map data is extracted from the SEM image and the pattern image is converted into pattern data configured by vector data.

Next, by a vector data comparison or a pattern matching between the first profile line which is formed and layout data 2604, a superposition (correspondence) of the layout data 2604 and the first profile line is performed (step 2703). The layout data 2604 is line segment information of design data which is stored in a GDS format and the like. After the superposition is performed, brightness distribution information collecting region is set to be normal to the first profile line 2604 and the brightness distribution is detected (step 2704). The pixel having a predetermined brightness of the brightness distribution formed in this manner is extracted and the position is defined as a second profile line position, and thus further formation of more accurate profile line becomes possible (step 2705).

In addition, already known methods which are described in JP-A-60-169977, JP-A-6-325176, JP-A-8-161508, JP-A-9-204529, and the like may be applied to the accurate profile line forming method.

Further, in the above example, the monitor pattern is actually exposed, and the characteristic amounts of the pattern shape is calculated based on the SEM image of the pattern which is obtained, however, without being limited thereto, the library may be prepared by, for example, an exposure simulation using the simulator 2405 and the like. Further, the library may be prepared using both of the shape information obtained by the SEM image and the shape information obtained using the simulator. In addition, both information is stored in the library, and when actually measured, both information is combined, so that the refinement of the exposure condition may be performed.

FIG. 22 is a diagram illustrating an outline of a calculation device inside the managing apparatus 2404. Inside a calculation device 2201, a SEM image acquisition unit 2202 for obtaining the image data from the CD-SEM 2401 and an acquired image storing unit 2209 for storing the image data are provided. A profile line extraction unit 2203 extracts profile line information from the obtained SEM image through the processes shown in FIG. 27. The information relating to the extracted profile line is stored in a profile line data storing unit 2210. Further, the SEM image acquisition unit 2202 or the profile line extraction unit 2203 may be installed in the control apparatus provided in the SEM, or the calculation device 2201 may selectively acquire necessary information from the control apparatus provided in the SEM.

A library preparation unit 2204 prepares a library through the processes shown in FIG. 3. Shape information for each pattern part and manufacturing information are associated to prepare the library, and the association information is stored in a library storing unit 2211. A curvature calculation unit 2205 calculates curvature data which is one of the shape information supplied in library preparation, based on profile line data stored in the profile line data storing unit 2210. With regard to the curvature of the corner portion of the pattern, for example, a plurality of curves having known curvatures are fitted to the obtained profile line and the curvature of the curve which is closest to the profile line may be determined as the curvature of the profile line, or other known curvature determination method may be applied. The information relating to the curvature determined as above, together with the information relating to the manufacturing condition is stored in the library. A comparison calculation unit 2206 compares the curvature data extracted based on the profile line data of the pattern which is formed in the mass production processes of the semiconductor with the curvature data stored in the library to determine an appropriated dose amount described below. The information relating to the dose amount determined in this manner is stored in a calculation result storing unit 2212. In the comparison process, the curvature data stored in the library is set to have a predetermined width, when curvature data appropriate for the width of the corresponding curvature data is obtained, the corresponding curvature data may be determined as curvature data stored in the library.

An exposure condition range specifying unit 2207 determines the focus range based on the dose amount stored in the calculation result storing unit 2212. The details thereof will be described later. In addition, a refinement unit 2208 performs refinement of the focus range or the like, based on a method described later. In addition, in the present embodiment, the example is described in which the exposure condition is associated with the shape information of the pattern (curvature and the like) and stored in the library, but it is not limited thereto, a flag showing each exposure condition and shape information are associated and stored, and the flag is specified, as a result, the exposure condition may be specified. In this case, the relationship between the flag and the condition of the exposing device is stored in an exposing device condition storing unit 2213, and the exposing device condition may be read based on the specification of the flag.

In addition, in an example of FIG. 22, a storing medium is embedded in the calculation apparatus, and, as necessary, a calculation unit is configured to access the storing unit, but the storing medium may be provided outside the calculation device and the calculation device may access the storage unit as necessary.

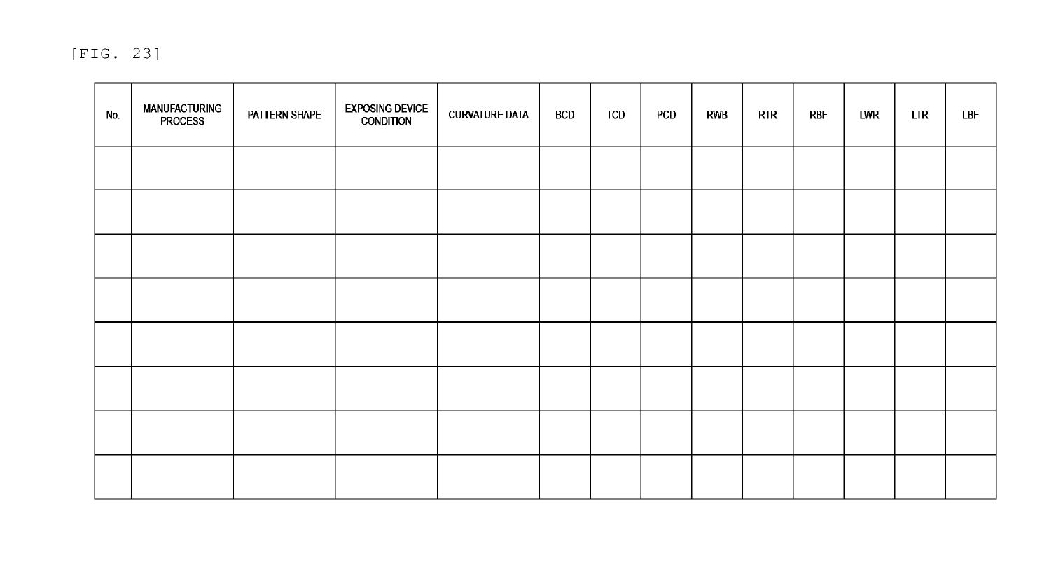

FIG. 23 is a diagram illustrating an example of the library, which is stored in the library storing unit 2211. In the present example, a manufacturing condition, a pattern shape (for example, a corner type), a condition of the exposing device, curvature data and other pattern shape information which is used in refinement of other conditions of the exposing device, and the like are associated and stored. The details of the pattern shape information will be described later.

FIG. 4 is a diagram for illustrating an outline of a process for estimating the exposure amount and the focus amount using the prepared library in the mass production process of the semiconductor wafer actually using the exposing device. In the present embodiment, an example is described in which both a pattern which is actually formed on a semiconductor device and a FD monitor pattern exist together on the wafer, however, without being limited thereto, for example, an evaluation of the exposure condition may be performed using an actual pattern corresponding to the FD monitor pattern.

The example of FIG. 4 illustrates an example in which the image acquisition condition, in which the image on the FD monitor is obtained, is prepared by the recipe preparation apparatus. Since the FD monitor pattern is stored also in the design data (layout data), the image acquisition condition may be determined based on the coordinate information. In the present embodiment, the managing apparatus 2404 functions as the recipe preparation apparatus.

The calculation device calculates the line width and the curvature of the patterns constituting the corner portion with respect to each part of the monitor pattern formed in the manufacturing process of the mass production wafer. In addition, the chip which becomes an object of this calculation is different from the FEM wafer used in the step of library preparation and is a wafer of an uniform condition adjusted to the dose and the focus which are optimized for manufacturing a production device, and thus a chip within a range of a region defined as a process window is targeted.

For estimating in which dose and focus a wafer is exposed, that is manufactured in the mass production process, using a FD monitor pattern as described above, the correlation between an exposure condition and the curvature calculated in the step of library preparation is obtained, and thus the exposure condition, which is associated with the most coincident curvature and stored, becomes the estimation value.

At this time, when a plurality of the coincident curvatures are detected inside the library, a white band of the SEM image calculated at the time of line width measurement is added as an index of the estimation, and thus the coincident focus may be determined from the inclination and the curvature of the white band.

Next, the library is searched from the measurement values of the line width of the monitor pattern mounted in the product wafer and the coincident dose value is calculated. At this time, when a plurality of dose values are calculated, estimation may be performed by taking the most coincident dose value from the above determined focus value and the measurement value of the line width as a true value.

As a result, when the focus value and the dose value which are obtained by the estimation are different from the optimal value which is set in advance, an apparatus management job such as an exposing device adjustment is performed and a job to maintain the state of the product manufacturing process is performed.

The adjustment amount calculation portion shown in FIG. 4 calculates a difference between the drawn estimation exposure condition and ideal exposure condition to output the value as an adjustment amount. The adjustment amount calculation portion may be provided in the exposing device, or embedded in the managing apparatus 2404.

According to the above configuration, it is possible to realize an efficient recipe preparation for an exposing device adjustment for each product device. When the product device is newly manufactured, in order to grasp the status of the exposing device that is previously adjusted, by using the estimation method described above, an efficient adjustment job of a recipe which controls an operation of the exposing device is possible. In the present method, using a monitor pattern which covers an entire surface of a wafer, by estimating a dose and focus of the exposing device, an evaluation of an uniformity of a pattern finish inside the wafer surface is performed, an achievement status of the desired finish is detected, and an recipe adjustment which performs a recipe verification become possible.

In addition, in a mass production process, by performing an evaluation of a FD monitor pattern, it is possible to manage the exposing device fast, and it becomes possible to, or aim to, maintain a yield without lowering production efficiency.

In addition, since an estimation failure result is obtained in a case where the pattern finish deteriorates, by using the failure value, it is possible to detect a failure of the pattern manufacture process and measure a process improvement.

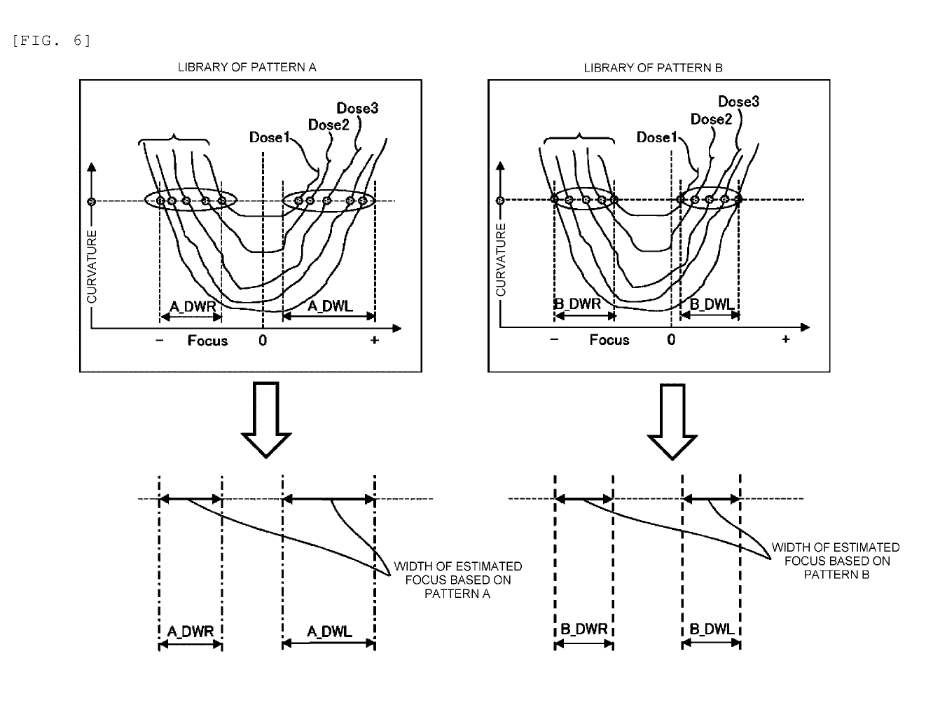

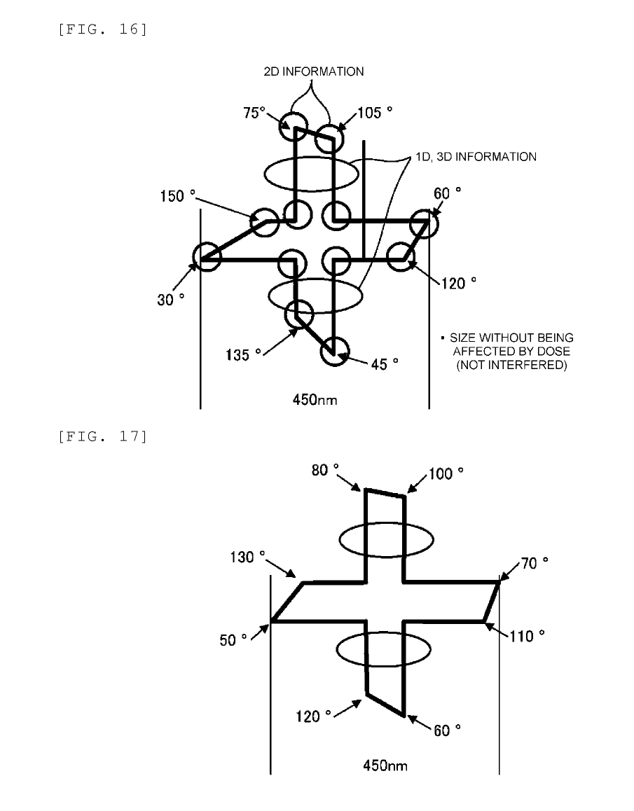

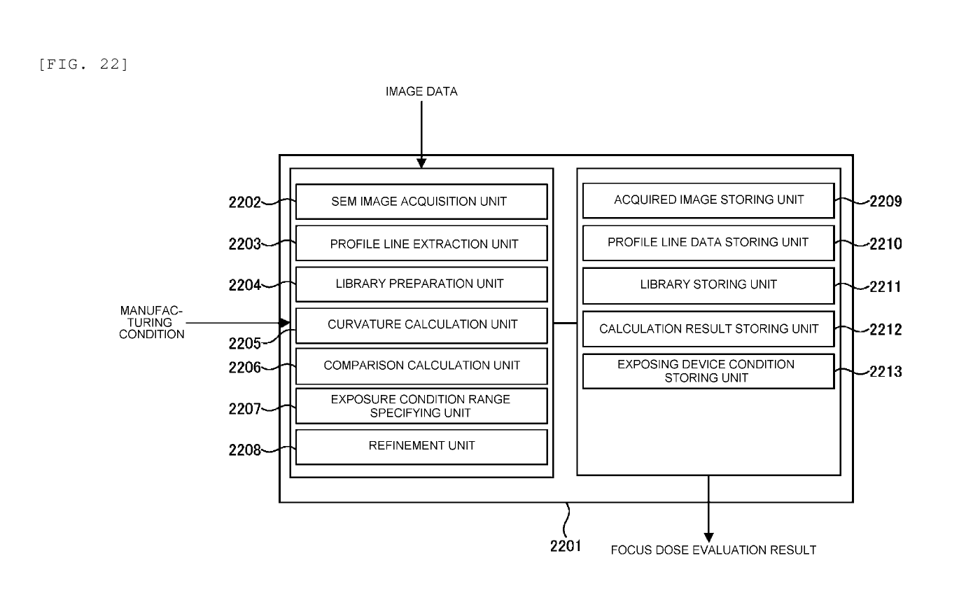

Hereinafter, more specifically, the estimation method of the exposure condition of the exposing device will be described. FIG. 5 is a diagram illustrating an example of a graph showing a relationship between the curvature formed based on information stored in the DF estimation library and the focus amount of the exposing device. In the present example, for each different dose amount, a curve showing a relationship between the change in the curvature and the change in the focus amount is formed. FIG. 21 shows a flowchart showing the exposure condition estimation process using the DF estimation library. First, a SEM image of a FD monitor pattern which is an object is acquired (step 2101). Next, the pattern edge is made into a profile line using aforementioned method and the like (step 2102). Then, curvatures of various corner portions (ROI: Region Of Interest) of a FD monitor pattern are calculated as a target curvature (step 2103). As a position of a reference to obtain the curvature, as shown in FIG. 15, it is possible to set intersecting points between the profile line and a plurality of straight lines (reference lines L, M, N) which extend from any positions which is determined with the design data as a reference and are normal with respect to the profile line. A plurality of reference positions for profile line determination are set, thereby increasing the accuracy of curvature calculation of the profile line.

Next, curvature data of the calculated target are compared with curvature data of the pattern part at the same position as that of the target stored in the library (step 2104). In addition, curvature data and a focus value for each of the plurality of doses are associated and stored in the library. That is, with respect to one curvature, a plurality of focus amounts may be stored in the library. That is, as shown in FIG. 5, with respect to a certain curvature, a plurality of dose amounts are associated on the library data, the focus value which is associated with the plurality of dose amounts has the width. Further, in both cases where the focus value is negative (under focus) and where the focus value is positive (over focus), the focus value having a certain width is detected. In the present embodiment, the width of the focus value having certain curvature data on the negative side is defined as X_DWR and the width of the focus value having certain curvature data on the positive side is defined as X_DWL. X is a variable that changes according to the type of the pattern.

The comparison with the library which is performed in step 2104 is performed for each predetermined pattern number or each predetermined pattern part (step 2105). In this manner, with respect to a plurality of evaluation object, data corresponding to X_DWR and X_DWL is calculated. FIG. 6 illustrates an example in which libraries of two patterns (a pattern A and a pattern B) and curvature data are compared and the focus width (A_DWR, A-DRL) and (B-DWR, B_DRL) of respective patterns are calculated.

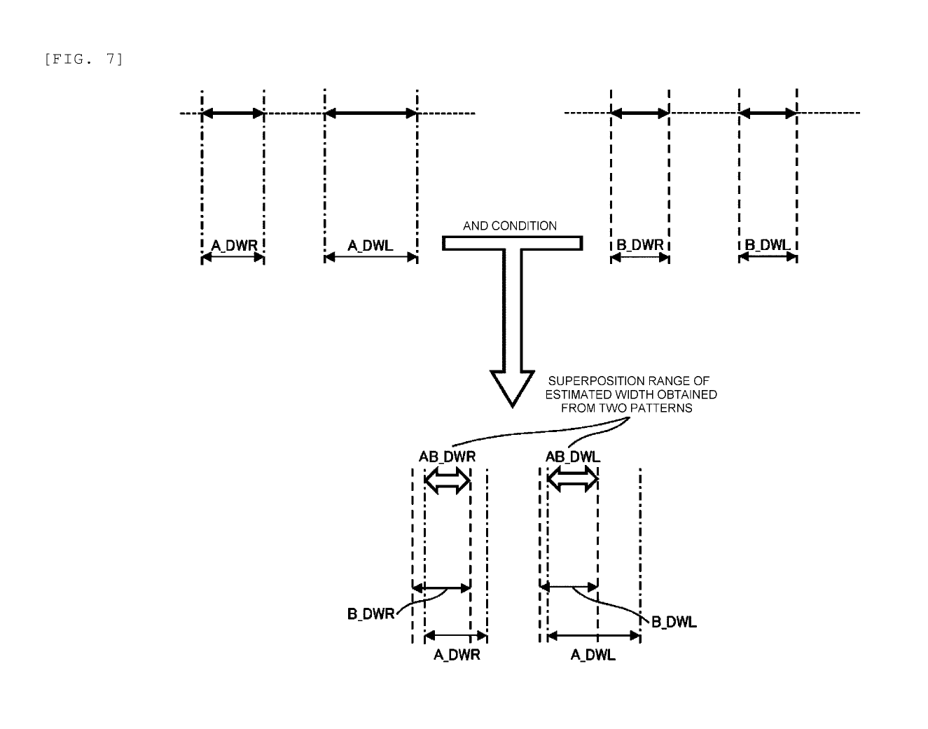

By obtaining a logical product of the focus widths of a plurality of patterns which is obtained in this manner, refinement of DWR and DWL is performed (step 2106). FIG. 7 illustrates an example of a process which obtains superposed regions (AB_DWR, AB_DWL) of focus widths of two patterns.

As described above, for each pattern or pattern part which shows a different change according to a change in a focus condition, focus widths are obtained and a logical product thereof is calculated, so that it is possible to refine the focus widths, as a result, it is possible to specify an accurate focus (step 2107). Although in the present embodiment, an example is described in which two different patterns or pattern parts are set as targets, without limited thereto, for example, refinement using pattern parts of three or more may be performed. As the number of target is large, the focus width may be refined to the narrower range.

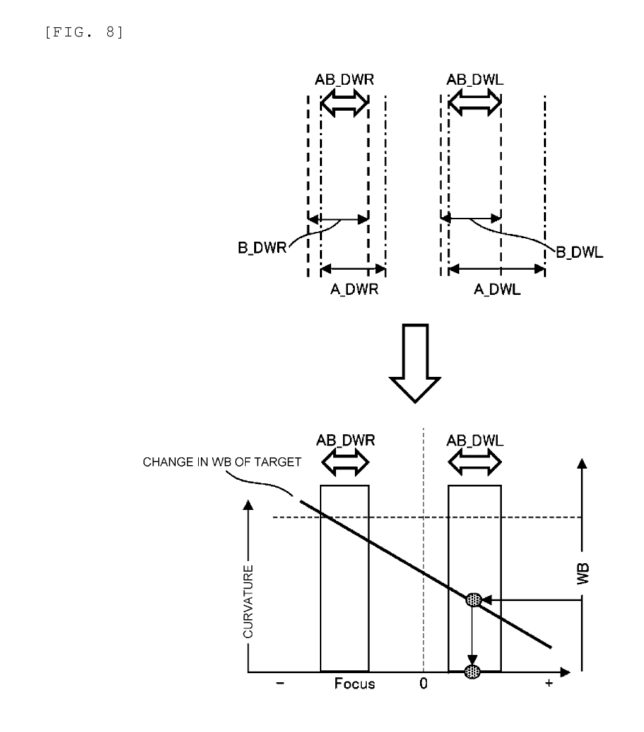

Further, in the present embodiment, the case is explained in which a focus width, which is extracted through the process shown in FIG. 21, is not yet fully refined, but has a certain width. Hereinafter, in a case where the exposing device condition is not yet sufficiently refined even after passing the above processes, a method for further realizing the refinement will be described. FIG. 8 is a diagram illustrating the outline thereof. In the present embodiment, using data other than curvature data, a method for further performing the refinement is described. FIG. 8 shows a method for performing the refinement of the focus width based on information of the white band of a pattern edge. In order to employ the method, in advance, in the library, information of a white band of any position of the pattern (an indication value relating to the white band such as the width of the white band, brightness variation information and the like) and information relating to the exposure condition of the exposing device need to be associated with each other and stored. Information relating to the white band extracted from a SEM image which is actually obtained and the library are compared, focus data associated with the information relating to the white band is extracted and used in the refinement, and thereby performing a specification of more correct focus amount.

As described above, while the refinement is performed using a curvature present in the curved portion of the pattern which sensitively responds with respect to the change in the exposure condition, other pattern information is added, so that a more accurate estimation of the exposure condition may be performed.

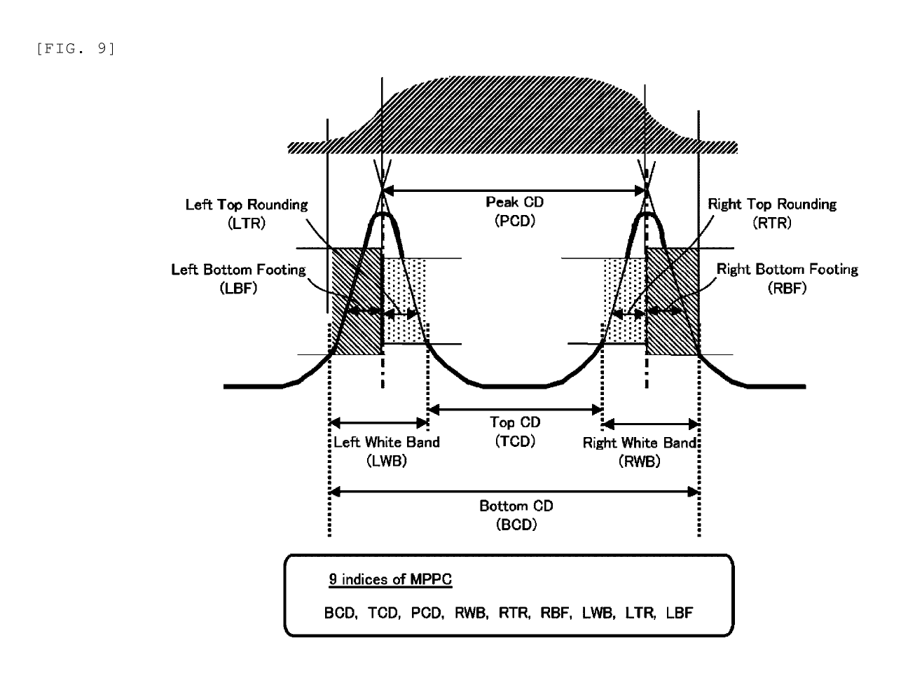

FIG. 9 is a diagram illustrating other pattern information for performing refinement of the exposure condition. At least one of nine pieces of information as shown in FIG. 9 is registered in the library, and compared with the information extracted from the SEM image, and thus the refinement of the exposure condition may be performed. FIG. 9 shows that Bottom CD (BCD), Top CD (TCD), Peak CD (PCD), Right White Band (RWB), Right Top Rounding (RTR), Right Bottom Footing (RBF), Left White Band (LWR), Left Top Rounding (LTR) and Left Bottom Footing (LBF) may be extracted from the line profile which is obtained based on the SEM image. The information is information obtained from the line profile and is information which may be extracted at the time of library preparation or actual measurement.

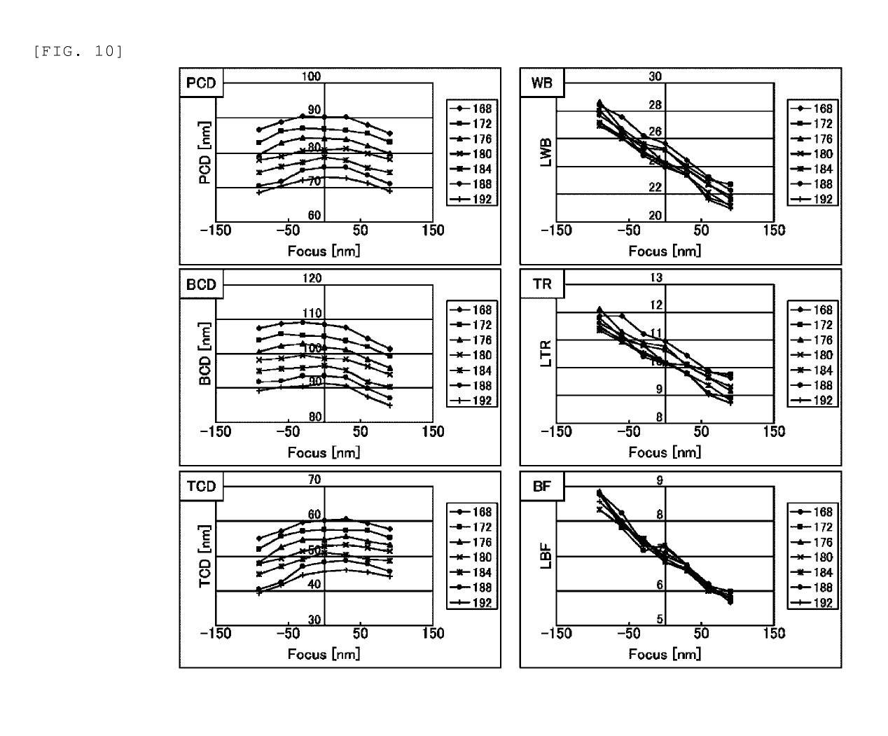

As shown in FIGS. 10 and 11, in the relationship with the focus value of the exposing device, since especially the white band shows a linear change, the white band is suitable for being applied to the refinement of the exposure condition.

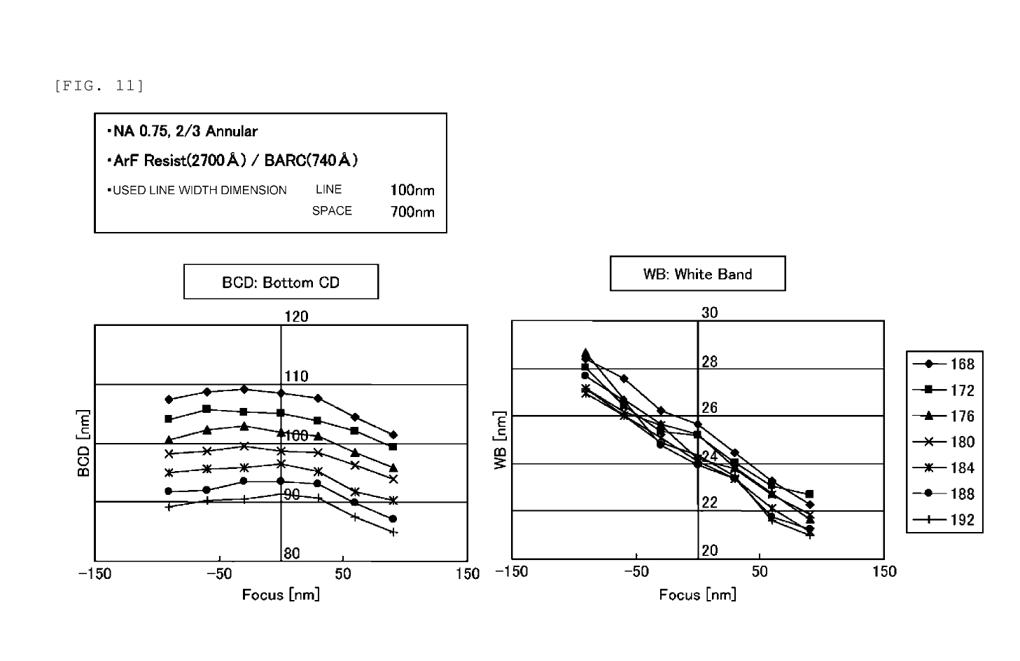

Next, a method of estimating a dose amount based on the estimation focus value which is estimated in advance is described using FIG. 12. In the present example, the dose amount is estimated using the estimation focus value which is calculated in advance and a dimension value (a CD value) of the target. More specifically, the dose amount having a coincident CD value among a plurality of dose amount (or a dose width) that corresponds to the estimated focus value is set as the estimated dose amount. Since in the library, the dose amount and the CD value (the dimension value illustrated in FIG. 9 and the like) are associated and stored, the accurate dose amount may be specified by contrasting the CD value obtained from the SEM image with the library.

In the present embodiment, the example is mainly described in which the monitor pattern is formed on the sample (the semiconductor wafer) that is mass produced, separately from the pattern to actually form the semiconductor pattern. A preferred condition of the monitor pattern includes the following conditions.

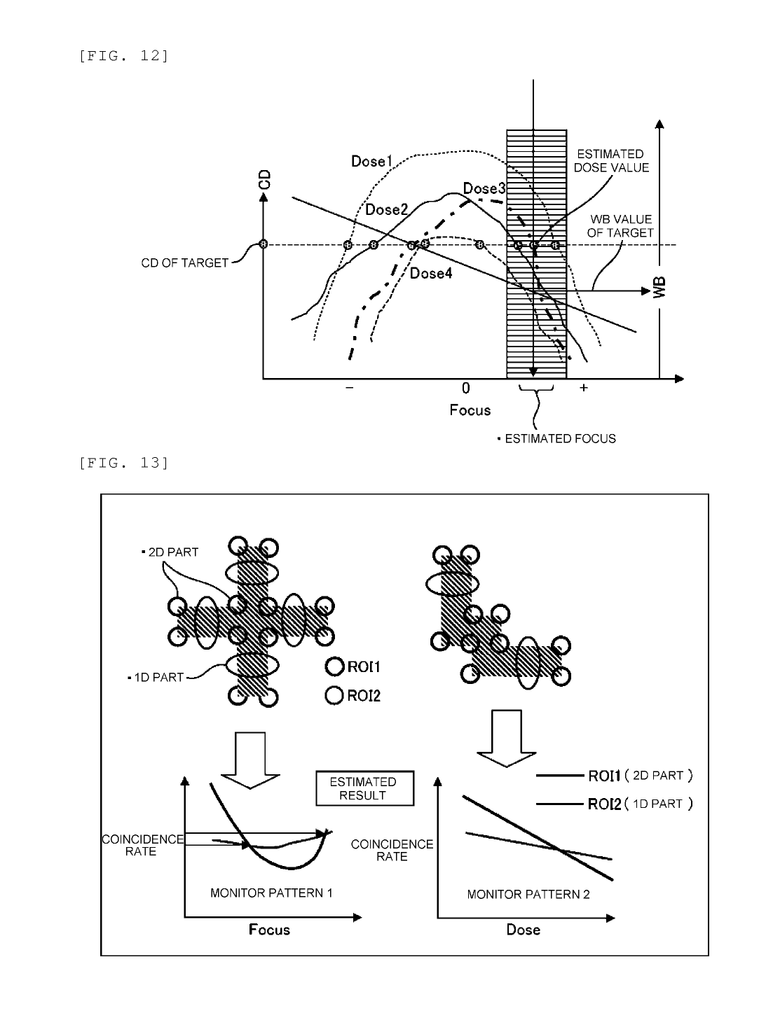

For example, as shown in FIG. 13, the preferred condition includes a condition in which a plurality of curved portions for specifying two-dimensional information are present, may be disposed in plural parts inside the chip, and may be disposed inside the device chip, and a condition in which information inside the shot of the exposing device such as a scanner is obtained.

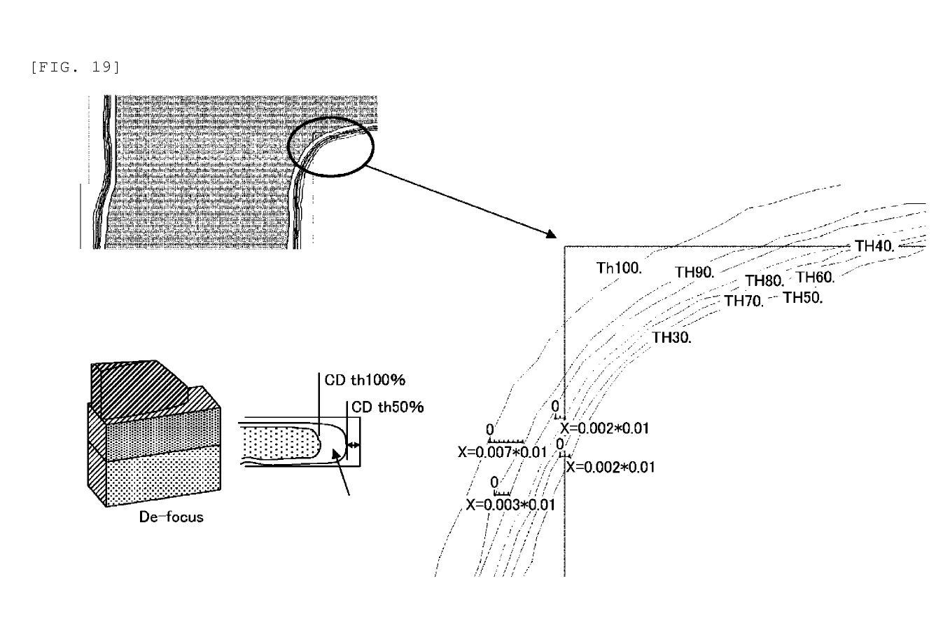

Further, in order to increase information amount for estimation, not only two-dimensional information such as the curvature of the curved portion of the pattern, but also one-dimensional information such as a size value or three-dimensional information such as a cross sectional shape is extracted to be obtained. Furthermore, the measurement time may be restricted by making a pattern of a size which fits into a measurement magnification ratio of the scanning electron microscope. Other than the pattern from which the curvature data is obtained, a distance between holes of contact holes is also employed as information for performing refinement, so that it is possible to improve an accuracy of estimation. As shown in FIG. 18, if the focus condition of the exposing device is changed, an interval between holes tends to be changed, so that it may be said that the interval is a preferred parameter for performing refinement of the exposure condition.

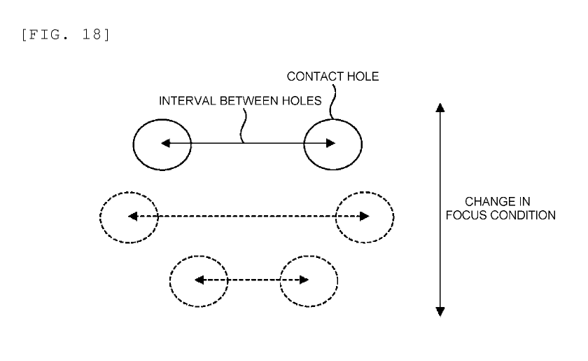

Further, as shown in FIGS. 16 and 17, by employing a pattern of which the number of corners is large and in which there are many variations in angles of corners, it is possible to raise an accuracy of the refinement. Further, it is possible to realize an improvement of reproducibility using average, by using a plurality of information of a corner of the same shape (direction). Further, by taking the corner portion and the straight line portion as evaluation objects, the corner portion and the straight line portion are considered to show different actions due to the change in the exposure condition, therefore it is possible to perform refinement based on a different index.

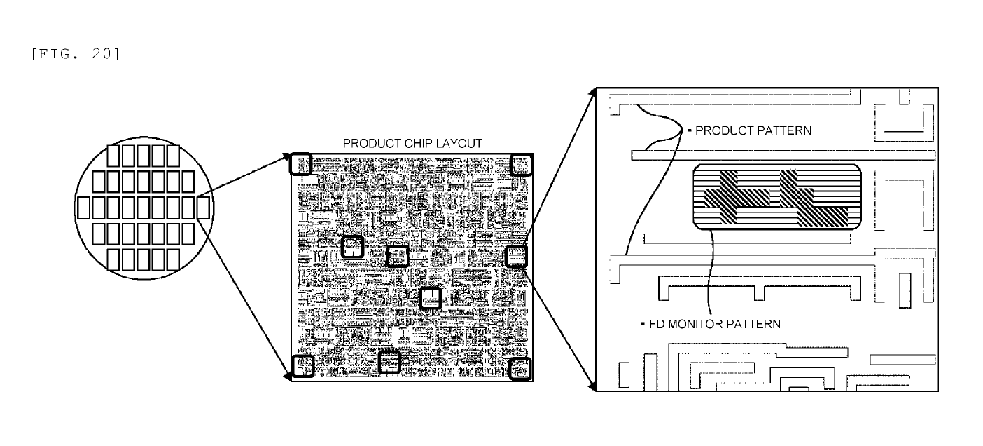

First, in order for three-dimensional information together with one-dimensional information or two-dimensional information to be applied as information for refinement, as shown in FIG. 19, shape information of a side wall of a pattern edge is stored in the library, and the refinement of the exposure condition may be performed using the shape information of the side wall. FIG. 19 illustrates an example in which based on waveform profile of each part of a pattern used in profile line extraction, with regard to an edge portion, information in the height direction of each part is obtained, and the corresponding side wall information is stored in the library to be used as an index for refinement.

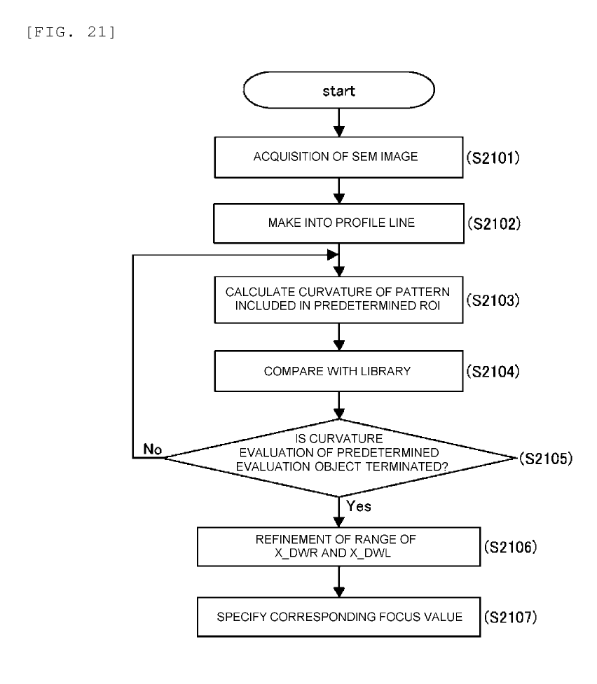

FIG. 20 is a diagram for illustrating an example in which a pattern that is not present in the product design data is installed as a monitor pattern on a wafer.

As a place where the monitor pattern is disposed, an area without any meaning in a circuit such as a non-occupied place on a layout or a vicinity of a dummy pattern for CMP is used.

With regard to recipe preparation for measurement of a monitor pattern, a series of recipe information for measurement referred to as an addressing position and an auto focus position may be automatically prepared by analyzing design data taking the coordination of the position where the monitor pattern is disposed as an input.

In addition, since an automatic recognition of an individual measurement part (ROI) of a corner portion and the like such as the cross-shaped pattern as described above may be recognized on the design data, a recipe preparation for a monitor which is possible to do, fully automated, off-line.

### REFERENCE SIGNS LIST

2401, 2402 a CD-SEM
2403 a defect review SEM
2404 a managing apparatus
2405 a simulator
2406 a storing medium

1. A managing apparatus of a semiconductor manufacturing apparatus comprising:
a library which stores an association between curvature information of a curved portion of a pattern and an exposure condition of an exposing device or a flag provided to specify the exposure condition; and
a calculation device which compares curvature information of a pattern extracted from image information with the curvature information stored in the library and extracts an exposure condition or a flag corresponding to the curvature information of the pattern extracted from the image information.

2. The managing apparatus of a semiconductor manufacturing apparatus according to claim 1,
wherein the exposure condition of the exposing device and dimension information of the pattern and/or cross sectional shape information of the pattern are associated and stored in the library.

3. The managing apparatus of a semiconductor manufacturing apparatus according to claim 1,
wherein the calculation device includes a profile line extraction unit which extracts a profile of an edge portion of an image obtained by a scanning electron microscope.

4. The managing apparatus of a semiconductor manufacturing apparatus according to claim 1,
wherein the library associates and stores curvature information of a plurality of parts of the pattern and a plurality of exposure conditions, and
wherein the calculation device compares a plurality of the pieces of curvature information extracted from the image information with a plurality of curvature information stored in the library and extracts an exposure condition corresponding to the curvature information of the pattern extracted from the image information.

5. A computer program which instructs a calculation device to estimate, based on pattern data extracted from image information, an exposure condition of an exposing device that forms a pattern,
wherein the program instructs the calculation device to access a library which stores an association between curvature information of a curved portion of a pattern and the exposure condition of the exposing device or a flag provided to specify the exposure condition, compare curvature information of a pattern extracted from image information with the curvature information stored in the library, and extract an exposure condition corresponding to the curvature information of the pattern extracted from the image information.

6. A managing apparatus of a semiconductor manufacturing apparatus comprising:
a library which stores an association between shape information of patterns of a plurality of positions and an exposure condition of an exposing device or a flag provided to specify the exposure condition; and
a calculation device which compares the shape information of the plurality of positions extracted from image information with the shape information stored in the library, and extracts the exposure condition based on a logical product of a range of a plurality of exposure conditions corresponding to the shape information of the plurality of patterns extracted from the image information, or a range of a plurality of the exposure conditions obtained based on a plurality of the flags provided to specify the range of the exposure conditions.

7. The managing apparatus of a semiconductor manufacturing apparatus according to claim 6,
wherein the shape information of the pattern includes the curvature information of the pattern.

8. The managing apparatus of a semiconductor manufacturing apparatus according to claim 6,
wherein the curvature information of the pattern and information relating to other characteristic amounts of the pattern are stored as the shape information of the pattern in the library, and
wherein the calculation device performs refinement of the extracted exposure condition based on the other characteristic amounts of the pattern.

9. The managing apparatus of a semiconductor manufacturing apparatus according to claim 6,
wherein the other characteristic amounts of the pattern are dimension information of the pattern and/or cross sectional information of an edge of the pattern.

10. The managing apparatus of a semiconductor manufacturing apparatus according to claim 6,
wherein the calculation device extracts a focus range for each shape information of the plurality of positions based on the association between the shape information of the plurality of positions stored in the library and a focus condition of the exposing device, and performs refinement of the focus range of the exposing device based on the logical product of the extracted focus information.

11. The managing apparatus of a semiconductor manufacturing apparatus according to claim 10,
wherein the calculation device further refines the refined focus range using the other characteristic amounts of the pattern.

12. The managing apparatus of a semiconductor manufacturing apparatus according to claim 6,
wherein the calculation device specifies a focus condition of the exposing device based on the logical product and specifies a dose condition of the exposing device based on the specified focus condition and the other characteristic amounts of the pattern.

13. The managing apparatus of a semiconductor manufacturing apparatus according to claim 6,
wherein curvature information of a plurality of parts having different degrees in the pattern is stored in the library.

14. A computer program which instructs a calculation device to estimate, based on pattern data extracted from image information, an exposure condition of an exposing device that forms a pattern,
wherein the program instructs the calculation device to access a library which stores an association between shape information of patterns of a plurality of positions and an exposure condition of an exposing device or a flag provided to specify the exposure condition, compare the shape information of the plurality of positions extracted from image information with the shape information stored in the library, and extract the exposure condition based on a logical product of a range of a plurality of exposure conditions corresponding to the shape information of the plurality of patterns extracted from the image information, or a range of a plurality of the exposure conditions obtained based on a plurality of the flags provided to specify the range of the exposure conditions.
